(19) United States
(12) Patent Application Publication
(10) Pub. No.: US 2024/0144033 A1
(43) Pub. Date: May 2, 2024

(54) KNOWLEDGE REUSE METHODS AND SYSTEMS

(71) Applicant: ALIPAY (HANGZHOU) INFORMATION TECHNOLOGY CO., LTD., Hangzhou (CN)

(72) Inventors: Lei Liang, Hangzhou (CN); Yuxiao He, Hangzhou (CN)

(73) Assignee: ALIPAY (HANGZHOU) INFORMATION TECHNOLOGY CO., LTD., Hangzhou (CN)

(21) Appl. No.: 18/499,988

(22) Filed: Nov. 1, 2023

(30) Foreign Application Priority Data
Nov. 2, 2022 (CN) 202211361842.0

(51) Int. Cl. G06N 5/02

(52) U.S. Cl. CPC G06N 5/02

(57) ABSTRACT

This specification relates to the field of knowledge graphs, and in particular, to knowledge reuse methods, apparatuses, computer-readable media, and systems. In an example computer-implemented method, a child entity is defined based on a parent entity, where the parent entity is selected from entities in a knowledge graph. A knowledge inheritance method is performed to inherit a portion of instance data of the parent entity. Instance data of the child entity are determined. First graph increment information corresponding to the instance data of the child entity is stored.

### CROSS-REFERENCE TO RELATED APPLICATIONS

This application claims priority to Chinese Patent Application No. 202211361842.0, filed on Nov. 2, 2022, which is hereby incorporated by reference in its entirety.

### TECHNICAL FIELD

This specification relates to the field of knowledge graphs, and in particular, to knowledge reuse methods and systems.

### BACKGROUND

Knowledge reuse is the process of creating new value by using existing knowledge. Knowledge is usually expressed in the form of a knowledge graph. The knowledge graph is a knowledge base including a series of entity instances and relationships between the entity instances. Knowledge reuse can fuse knowledge graphs generated in different service fields to integrate and improve knowledge of an original graph, and can also perform knowledge processing and mining based on the existing knowledge graph to generate new knowledge. How to provide an efficient knowledge reuse method becomes a problem to be urgently solved. Therefore, this specification provides knowledge reuse methods and systems.

### SUMMARY

One or more embodiments of this specification provide knowledge reuse methods. The method includes the following: a child entity is defined based on a parent entity, where the parent entity is selected from entities in a knowledge graph; a knowledge inheritance method is performed, to inherit a portion of instance data of the parent entity, and then determine instance data of the child entity; and first graph increment information corresponding to the instance data of the child entity is stored.

One or more embodiments of this specification provide knowledge reuse systems. The system includes: a child entity definition module, configured to define a child entity based on a parent entity, where the parent entity is selected from entities in a knowledge graph; a knowledge inheritance module, configured to perform a knowledge inheritance method, to inherit a portion of instance data of the parent entity, and then determine instance data of the child entity; and an increment storage module, configured to store first graph increment information corresponding to the instance data of the child entity.

One or more embodiments of this specification provide knowledge reuse apparatuses. The apparatus includes a processor and a storage medium, where the storage medium is configured to store computer instructions, and the processor is configured to execute at least some of the computer instructions to implement any one of the above-mentioned knowledge reuse methods.

### BRIEF DESCRIPTION OF DRAWINGS

This specification will be further illustrated by way of example embodiments that will be described in detail with reference to the accompanying drawings. These embodiments are not limiting. In these embodiments, the same reference numeral represents the same structure.

FIG. 1 is an example flowchart illustrating a knowledge reuse method, according to some embodiments of this specification;

FIG. 2 is a schematic diagram illustrating knowledge fusion, according to some embodiments of this specification;

FIG. 3 is a schematic diagram illustrating knowledge processing, according to some embodiments of this specification; and

FIG. 4 is an example diagram illustrating modules of a knowledge reuse system, according to some embodiments of this specification.

### DESCRIPTION OF EMBODIMENTS

To describe the technical solutions in embodiments of this specification more clearly, the following briefly describes the accompanying drawings needed for describing the embodiments. Clearly, the accompanying drawings in the following description are merely some examples or embodiments of this specification. A person of ordinary skill in the art can still apply this specification to other similar scenarios based on these accompanying drawings without creative efforts. Unless clear from the language environment or otherwise stated, the same reference numeral in the figure represents the same structure or operation.

It should be understood that the terms “system”, “apparatus”, “unit”, and/or “module” used here are used to distinguish between different components, elements, parts, portions, or assemblies of different levels. However, if other terms can achieve the same purpose, the term can be replaced by other expressions.

As shown in this specification and the claims, the terms “one”, “a”, and/or “the”, etc. may not be in a singular form, and may be in a plural form unless the context expressly suggests exceptions. Generally, the terms “include” and “contain” indicate only those steps and elements that have been explicitly identified, these steps and elements do not constitute an exclusive listing, and the method or device may also include other steps or elements.

A flowchart is used in this specification to describe operations performed by a system according to embodiments of this specification. It should be understood that the operations may not be accurately performed in sequence. Instead, the steps can be processed in reverse order or simultaneously. In addition, other operations can be added to these processes, or one or more operations can be removed from these processes.

To facilitate the description of the solution in this specification, a definition and a technology related to a knowledge graph are described first.

A knowledge graph is a knowledge base including a series of entity instances (that is, instance data corresponding to entities) and relationships between the entity instances (which may also be referred to as instance data of edges). An entity is an extensive abstraction of an objective individual, and can be a tangible object, for example, a person, a car, or a merchant, in the physical world, or can be an intangible object, for example, a discourse, a song, a movie, a fund, or program code. The entity instance can be a real example corresponding to an abstract concept of the entity. For example, the person can be specifically Amy, Mark, John, etc., the song can be specifically Blue and White Porcelain, Nightingale, Swan Lake, etc., and the merchant can be specifically merchant A, merchant B, merchant C, etc. There can be a relationship between entity instances. For example, there is a business relationship between merchant A and merchant B, merchant C is a child merchant of merchant A, and Amy is a manager of merchant A. In some embodiments, the relationship between entity instances can also be considered as a relationship between corresponding entities. For example, a management relationship or an employment relationship can exist between a person and a merchant. In some embodiments, an entity instance in the knowledge graph can be represented by a node, and a relationship between entity instances can be represented by an edge connecting nodes.

The knowledge graph can correspond to ontology definition data, which is also referred to as a schema of the knowledge graph. The ontology definition data of the knowledge graph are data that define entities and relationships between the entities included in the knowledge graph, and can represent semantic information of instance data of ontology of the knowledge graph. The ontology definition data of the knowledge graph can guide collection of the instance data and perform mapping based on the instance data to obtain the knowledge graph (also referred to as an instance graph or a data graph). Therefore, in some embodiments, the ontology definition data of the knowledge graph can include entity fields for defining entities. The entity field can be understood as a type of an entity or an entity representation. For example, the entity field can be “company entity”, “user”, “city”, etc., and the value of the entity field can be the previous entity instance, for example, “XX Science and Technology Co., Ltd.”, “Amy”, and “Beijing”. The entity field can correspond to a plurality of attribute fields, and the attribute field can be an abstraction of entity description information. For example, the attribute field can be “address”, “age”, “registration capital”, etc., and the value of the attribute field can be a specific description (also referred to as attribute data) of an entity instance corresponding to the attribute field, for example, “No. 11 Jianshe Road”, “28 years old”, or “five million”. In some embodiments, the ontology definition data of the knowledge graph can include a relationship description used to define a relationship between entities, and the relationship description can be an abstraction of a type of the relationship between entities, for example, “employment relationship”, “parent-subsidiary company relationship”, or “parent-child relationship”. In some embodiments, the relationship description can further include a relationship attribute, and the relationship attribute is used to further describe the relationship description. For example, “employment relationship” can be specifically “temporary employment” or “formal employment”, and “parent-subsidiary company relationship” can further include “wholly-owned holding relationship”, “partially-owned holding relationship”, etc. It can be determined, by using the relationship description, whether there is an edge between two entity instances when the knowledge graph is constructed. In some embodiments, a graph operator can be further determined. The graph operator is used to identify entity instances from a large quantity of pieces of instance data and determine a relationship between the entity instances based on the entity definition or the relationship description. The graph operator can also be understood as a graph computing algorithm or method, and is used to perform a data processing operation for graph construction. The graph operator can be implemented in various forms such as a data processing/operation unit, program code, or a machine learning model. In some embodiments, for input data of an operator, the operator can perform corresponding data processing/operation, complete data conversion, and output converted data. In some embodiments, the graph operator can be considered as an algorithm or a method established on the ontology definition data (including the entity definition and the relationship description) of the knowledge graph, or as a part of the ontology definition data.

Knowledge processing can be understood as processing data in the knowledge graph to standardize, improve, or supplement knowledge information of the original knowledge graph. For example, unit standardization is performed on attribute data of an entity in the original knowledge graph, or same entities in the original knowledge graph are fused, or a new relationship between entities is mined in the original knowledge graph. Knowledge fusion can be understood as combining at least two knowledge graphs to obtain a more comprehensive fused knowledge graph. For example, same entities in at least two graphs are fused, or a new relationship is established for entities coming from different graphs.

To better implement knowledge processing or fusing, some embodiments of this specification provide knowledge reuse methods based on knowledge inheritance, to inherit an entity in an existing knowledge graph to obtain a more pertinent child entity. Child entity-based knowledge reuse can further deepen knowledge mining and utilization.

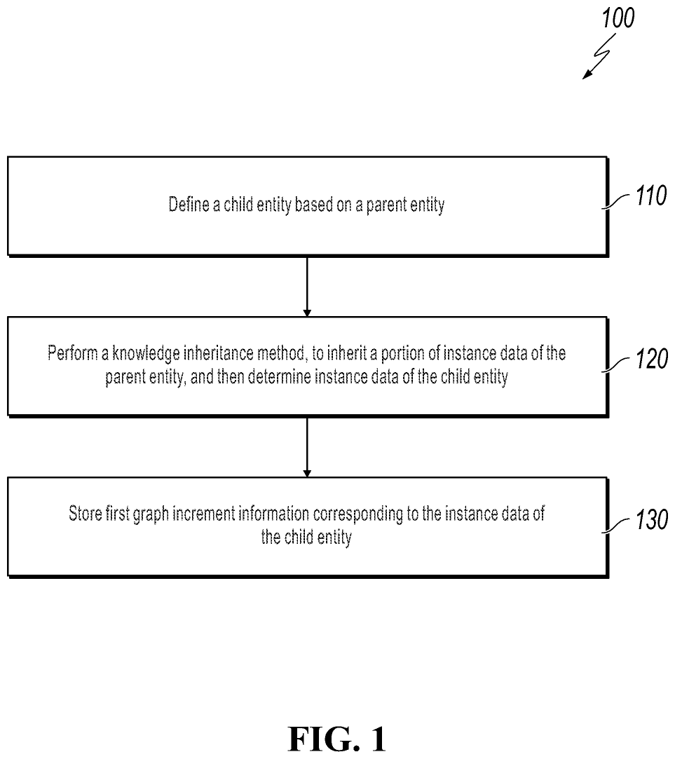

FIG. 1 is an example flowchart illustrating a knowledge reuse method, according to some embodiments of this specification.

Referring to FIG. 1, in some embodiments, one or more steps of a knowledge reuse method 100 in the figure can be performed by a processing device of a graph processing service platform. The method 100 includes the following steps:

Step 110: Define a child entity based on a parent entity, where the parent entity is selected from entities in a knowledge graph. In some embodiments, step 110 can be performed by a child entity definition module 410.

The parent entity is an entity (that is, an abstraction or summary of an entity instance) selected from the knowledge graph, and can be specifically represented by an entity field in a schema of the knowledge graph, for example, previously described “user” and “company”. A class is an abstraction of commonness of a class of objects with a same characteristic, and can be described by using an attribute and a behavior (or an algorithm or a method). An abstracted object can be referred to as an instance. To be distinguished from instance data in the knowledge graph, an instance of a class can be referred to as a class instance. The child entity can be considered as a child class of the parent entity, and has an attribute field and a method that are the same as those of the parent entity. For example, instance data of the child entity are a part of instance data of the parent entity. In some embodiments, the child entity can further include an attribute field and a method that are not available to the parent entity. In some embodiments, one or more child entities can be defined based on one parent entity. In some embodiments, the parent entity can come from a knowledge graph with more comprehensive data content.

In some embodiments, the instance data of the child entity are a subset of the instance data of the parent entity. For example, when the parent entity is “user”, the child entity can be a “male user”, “student user”, etc. in instance data of “user”. For another example, in some embodiments, in a transaction knowledge graph, a “company” entity can be selected as the parent entity, and the child entity can be defined as “listed company”.

For example, a child entity can be defined or declared by using the following statements:

```
CREATE Entity ListedCompany WITH
  GraphStructure {
  security_kg: Company a
}
Rule {
  a.listed = true
}
```

CREATE Entity ListedCompany WITH GraphStructure declares creating a child entity ListedCompany in a knowledge graph, security _kg is the name of a knowledge graph where a parent entity company is located, and a is class instance of company, which is essentially an entity rather than an entity instance. Rule is used to describe a screening condition, and defines that instance data of the child entity are instance data of the parent entity whose attribute “listed” has a value of “true”.

In some embodiments, values or attribute data of some attribute fields inherited by the child entity from the parent entity can be different from those of the parent entity. For example, an attribute value of a market value attribute of the parent entity company is settled in RMB, and an attribute value of a market value attribute of the child entity ListedCompany needs to be settled in USD. Therefore, to define the child entity, attribute data of one or more attribute fields inherited from the parent entity can be overridden.

For example, a child entity can be defined or declared by using the following statements, and attribute data of an inherited market value attribute field can be modified:

```
CREATE Entity ListedCompany WITH
  Graph Structure {
  security_kg: Company(
    override String marketValue
  ) a
}
Rule {
  a.listed = true
}
```

“override String marketValue” is a declaration statement of a method for overriding attribute data, and attribute data of a market value attribute marketValue are overridden here. String is a value type of the market value attribute, that is, a string type, and meanings of other statements are the same as those in the above-mentioned embodiments.

In other examples, an attribute field that is not available to the parent entity can be added to the child entity. For example, the parent entity company does not have an attribute field of company listing time. For the child entity listed company, listing time of each piece of instance data can be obtained from another data source. Therefore, one or more attribute fields can be added to the child entity when the child entity is defined.

For example, a child entity can be defined or declared by using the following statements, and an attribute field can be added to the child entity:

```
CREATE Entity ListedCompany WITH
  GraphStructure {
  security_kg:Company(
    extend Long listingTime
  ) a
}
Rule {
  a.listed = true
}
```

“extend Long listingTime” is a declaration statement of a method for adding an attribute field, and a listing time attribute field listingTime is added here. Long is a value type of the listing time attribute, and meanings of other statements are the same as those in the above-mentioned embodiments.

As previously described, a child entity can inherit a method of a parent class, that is, a parent entity, of the child entity, and in addition, the child entity can have a method dedicated to the child entity. Both the method for overriding attribute data and the method for adding an attribute field in the method declarations in the above-mentioned embodiments can be considered as methods of the child entity, which are also referred to as knowledge inheritance methods.

In some embodiments, the knowledge inheritance method can be a general term of methods for implementing inheritance from a parent entity. In a broad sense, the Rule statement in the above-mentioned declaration can also be considered as a knowledge inheritance method. Index information of instance data of the child entity is automatically generated after the declaration takes effect.

It is worthwhile to note that the knowledge inheritance method is not limited to the methods in the above-mentioned embodiments, and can be created based on an inheritance need in practice. For specific implementation of the knowledge inheritance method, references can be made to related descriptions in step 120.

After the declaration shown in the above-mentioned embodiments takes effect, definition data of the child entity can be identified in the schema of the knowledge graph where the parent entity is located. A child entity related method (for example, the method inherited from the parent entity or the knowledge inheritance method) can be considered as a graph operator in the schema of the knowledge graph where the parent entity is located. This provides a reference basis for subsequent knowledge processing or knowledge fusion.

Step 120: Perform the knowledge inheritance method, to inherit a portion of instance data of the parent entity, and then determine instance data of the child entity. In some embodiments, step 120 can be performed by a knowledge inheritance module 420.

The embodiments in step 110 only relate to a declaration of the method, and implementation code of the method is further included in practice. The instance data of the child entity can be determined when the code is executed. In some embodiments, the knowledge inheritance method is used to perform conditional screening on the instance data of the parent entity, and use instance data of the parent entity that satisfy a screening condition as the instance data of the child entity, to implement inheritance of a portion of instance data of the parent entity. Specifically, after the declaration statement in the above-mentioned embodiments takes effect, the processing device automatically creates a task, and obtains the instance data of the child entity from the instance data of the parent entity based on the screening condition of the Rule statement, to obtain index information of the instance data of the parent entity that satisfy the screening condition. The index information can be a storage address of the instance data, and further, the storage address can be an absolute address, an offset relative to a start location, etc.

In some embodiments, the knowledge inheritance method can modify one or more pieces of attribute data inherited in the instance data of the child entity, for example, the method for overriding attribute data. Specifically, when the method for overriding attribute data is performed, the processing device creates a task in a knowledge graph production link, obtains, from a specified data source, attribute data corresponding to an attribute field to be overridden in the instance data of the child entity, and uses the attribute data to override attribute data of the attribute field inherited from the parent entity. In some embodiments, attribute data used for overriding or replacement can alternatively be a result of performing an operation on original attribute data, and does not need to be obtained from another data source. For example, RMB-USD conversion can be performed on the attribute data of the market value attribute field inherited by the child entity ListedCompany from the parent entity company, and the result is used to override the original attribute data, to implement modifications to one or more pieces of attribute data inherited in the instance data of the child entity.

In some embodiments, the knowledge inheritance method is further used to add one or more pieces of attribute data such as the method for adding an attribute field to the instance data of the child entity. Specifically, when the method for adding an attribute field is performed, the processing device creates a construction task in a knowledge graph production process to construct an attribute field to be added. In addition, the construction task further obtains, from a specified data source, attribute data that are of the attribute field to be added and correspond to the instance data of the child entity.

Step 130: Store first graph increment information corresponding to the instance data of the child entity. In some embodiments, step 130 can be performed by an increment storage module 430.

In some embodiments, some or all of the instance data of the child entity come from the instance data of the parent entity. Therefore, redundant storage is no longer performed on instance data already stored in the knowledge graph, and only increment information is stored, so that occupation of storage space is reduced.

In some embodiments, the index information can be stored as the first graph increment information. The index information can be used to record which of the instance data of the parent entity are instance data belonging to the child entity, and occupation of the index information in the storage space is far less than that when the instance data of the child entity are repeated stored.

In some embodiments, when one or more pieces of attribute data inherited by the child entity are modified, the first graph increment information can further include modified attribute data in addition to the previous index information indicating the instance data of the parent entity that satisfy the screening condition. In some embodiments, when one or more pieces of attribute data are added to the instance data of the child entity, the first graph increment information can further include the added attribute data in addition to the previous index information indicating the instance data of the parent entity that satisfy the screening condition. In some embodiments, the modified or added data are stored as increment data, so that direct modifications to data of the knowledge graph (also referred to as the original knowledge graph) where the parent entity is located can be reduced, and a state before the attribute data are modified or added can be quickly restored when a problem occurs in the data or in other situations.

The first graph increment data can be considered as a part of the original knowledge graph. When the original knowledge graph is queried by using the child entity, the instance data of the child entity are returned, and when the original knowledge graph is queried by using the parent entity, the instance data of the parent entity are returned. Taking the listed company “XX Science and Technology Co., Ltd.” as an example, when a query is performed by using the child entity ListedCompany, USD market value and listing time of “XX Science and Technology Co., Ltd.” can be identified; and when a query is performed by using the entity company, RMB market value of “XX Science and Technology Co., Ltd.” can be identified. It can be seen that new entities are created for the original knowledge graph through knowledge inheritance, and these instances are often more pertinent, providing a basis for deepening knowledge processing or fusion.

In some embodiments, based on an actual production task, after the above-mentioned knowledge inheritance method is performed, further processing can be further performed by using a knowledge processing method or a knowledge fusion method based on the determined instance data of the child entity.

In some embodiments, knowledge inheritance can be performed when the original knowledge graph is created, or can be performed after the original knowledge graph already exists.

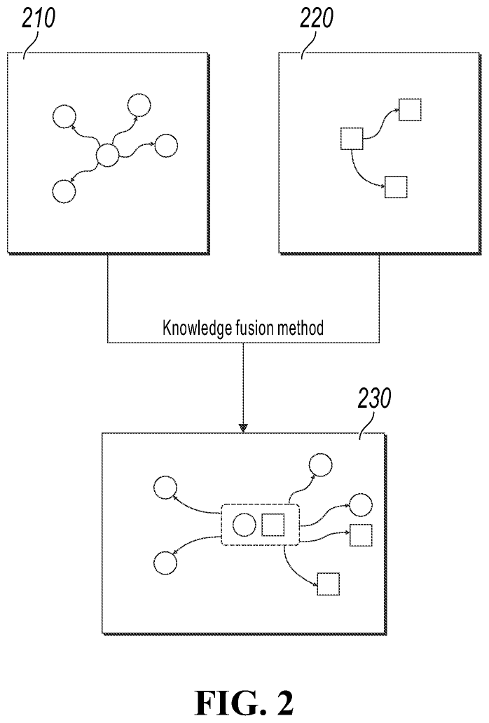

FIG. 2 is a schematic diagram illustrating knowledge fusion, according to some embodiments of this specification.

Referring to FIG. 2, in some embodiments, a first knowledge graph 210 and a second knowledge graph 220 can be fused to obtain a fused knowledge graph 230.

To obtain the fused knowledge graph based on the child entity, in some embodiments, the above-mentioned knowledge reuse method can further include the following steps: determining an entity to be fused, where the entity to be fused is selected from entities in another knowledge graph; and performing a knowledge fusion method, so that instance data of the entity to be fused and the instance data of the child entity are processed to obtain a fused knowledge graph.

The entity to be fused is an entity selected from another knowledge graph (for example, the second knowledge graph 220 in FIG. 2). In some embodiments, the instance data of the child entity obtained in step 120 may be associated with the instance data of the entity to be fused to a certain extent. The instance data of the entity to be fused and the instance data of the child entity that are associated can be processed by using the knowledge fusion method, to obtain the fused knowledge graph.

Referring to FIG. 2, in some embodiments, the association can be that the entity to be fused and the child entity are entities of a same type (for example, entities of a listed company type). The knowledge fusion method can be used to combine the entity to be fused and the child entity into a fused entity. Instance data of the fused entity can be a union of the instance data (including attribute data and relationship instances) of the entity to be fused and the child entity. The fused knowledge graph can include entities and relationships other than the child entity in the original knowledge graph, entities and relationships other than the entity to be fused in the another knowledge graph, and the fused entity and relationships thereof. For example, the fused knowledge graph is the fused knowledge graph 230. In some embodiments, the instance data of the entity to be fused and the instance data of the child entity may also overlap, that is, the entity to be fused and the child entity have instance data of a same instance. For example, the child entity has instance data “XX Science and Technology Co., Ltd.”, and the suitable to be fused also has the instance data of the company. The knowledge fusion method can further combine instance data belonging to a same instance to remove redundant instance data from the fused entity. In some embodiments, the above-mentioned knowledge fusion method can be implemented by using a graph operator (for example, an entity fusion operator). The graph fusion operator can correspond to program code, and is invoked when the fused knowledge graph is generated based on the instance data.

In some embodiments, the association can be that the entity to be fused and the child entity are not entities of a same type, but there is a certain relationship between the two entities. For example, the entity to be fused is a city, and the child entity is a listed company, and a territorial relationship can be established between the listed company and the city. Correspondingly, the knowledge fusion method can further generate instance data of an edge between the instance data of the entity to be fused and the instance data of the child entity, and the fused knowledge graph includes entities and relationships in the original knowledge graph, entities and relationships in the another knowledge graph, and the edge between the entity to be fused and the child entity.

In some embodiments, it can be determined, based on attribute data corresponding to the instance data of the child entity, whether a new association relationship exists between the instance data of the child entity and the instance data of the entity to be fused, so that a relationship description between the two entities can be established. In the previous example, an attribute field corresponding to the child entity ListedCompany includes “registration place”, and the entity to be fused is “city”. A relationship description between the instance data (for example, “XX Science and Technology Co., Ltd.”) of the child entity and instance data (for example, Shanghai) of “city” can be established based on attribute data (for example, Shanghai) of the attribute field “registration place” corresponding to the instance data “XX Science and Technology Co., Ltd.” of the child entity, to obtain a fused knowledge graph. In some embodiments, the above-mentioned knowledge fusion method can be implemented by using a graph operator (for example, an entity linking operator). The graph fusion operator can correspond to program code, and is invoked when the fused knowledge graph is generated based on the instance data.

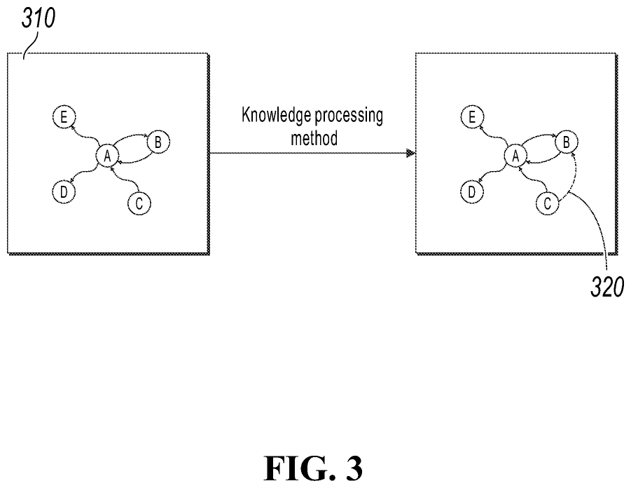

FIG. 3 is a schematic diagram illustrating knowledge processing, according to some embodiments of this specification.

Referring to FIG. 3, in some embodiments, the knowledge processing method can process, based on an actual production task, a knowledge graph 310 that the parent entity belongs to.

In some embodiments, the knowledge reuse method can further include the following steps: determining an entity to be fused, where the entity to be fused is selected from the entities in the knowledge graph; and performing a knowledge processing method, so that instance data corresponding to the entity to be fused and the instance data of the child entity are processed to obtain second graph increment data.

The entity to be fused can be selected based on a production task. The knowledge processing method is performed, to process the instance data corresponding to the entity to be fused and the instance data of the child entity, and obtain newly added or modified data, namely, second graph increment data 320.

In some embodiments, the knowledge processing method is used to generate instance data of an edge between the instance data of the entity to be fused and the instance data of the child entity, which is similar to the previous generation of the instance data of the edge between the instance data of the entity to be fused and the instance data of the child entity. In some embodiments, the instance data of the edge can be generated between the instance data of the entity to be fused and the instance data of the child entity by using a graph operator (for example, an entity linking operator). Details are omitted here for simplicity. In some embodiments, the second graph increment data include the newly added instance data of the edge.

It is worthwhile to note that the above-mentioned descriptions of the flow methods are merely for example and description, and do not limit the scope of application of this specification. A person skilled in the art can make various modifications and changes under the guidance of this specification. However, these modifications and changes still fall within the scope of this specification. For example, the knowledge fusion method or the knowledge processing method can be performed before step 130, or can be performed after step 130.

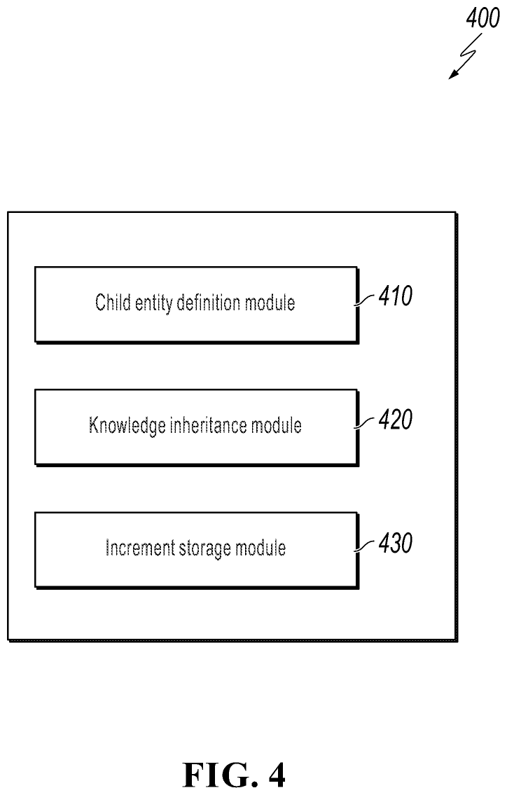

FIG. 4 is an example diagram illustrating modules of a knowledge reuse system, according to some embodiments of this specification.

A knowledge reuse system 400 shown in FIG. 4 can include a child entity definition module 410, a knowledge inheritance module 420, and an increment storage module 430.

The child entity definition module 410 can be configured to define a child entity based on a parent entity, where the parent entity is selected from entities in a knowledge graph.

In some embodiments, for more content about the parent entity and the child entity, references can be made to related descriptions in step 110, and details are omitted here for simplicity.

The knowledge inheritance module 420 can be configured to perform a knowledge inheritance method, to inherit a portion of instance data of the parent entity, and then determine instance data of the child entity.

In some embodiments, for more content about the knowledge inheritance method, references can be made to related descriptions in step 120. Details are omitted here for simplicity.

The increment storage module 130 can be configured to store first graph increment information corresponding to the instance data of the child entity.

In some embodiments, for more content about the first graph increment information, references can be made to related descriptions in step 130, and details are omitted here for simplicity.

It should be understood that the system shown in FIG. 4 and the modules thereof can be implemented in various forms. For example, in some embodiments, for example, in some embodiments, the apparatus and the modules thereof can be implemented by hardware, software, or a combination of software and hardware. The hardware part can be implemented by using dedicated logic. The software part can be stored in a memory and executed by an appropriate instruction execution apparatus, for example, a microprocessor or dedicated design hardware. A person skilled in the art can understand that the above-mentioned methods and apparatuses can be implemented by using computer executable instructions and/or included in processor controlled code. For example, such code is provided on a carrier medium such as a disk, a CD, or a DVD-ROM, a programmable memory such as a read-only memory (firmware), or a data carrier such as an optical or electronic signal carrier. The apparatuses and the modules thereof in this specification can be implemented by a hardware circuit of a semiconductor of a very large-scale integrated circuit or gate array, a logic chip, or a transistor, or a programmable hardware device such as a field programmable gate array or a programmable logic device, or can be implemented by software executed by various types of processors, or can be implemented by a combination (for example, firmware) of the previous hardware circuit and software.

It is worthwhile to note that the previous descriptions of the knowledge reuse system 400 and the modules thereof are for ease of description only, and cannot limit this specification within the scope of the embodiments described. It can be understood by a person skilled in the art that, after the principle of the system is understood, the modules can be randomly combined or the modules can constitute a subsystem to be connected to another module without departing from the principle. For example, in some embodiments, for example, the child entity definition module 410 and the knowledge inheritance module 420 disclosed in FIG. 4 can be different modules in a system, or can be one module that implements functions of the previous two or more modules. For example, the modules can share one storage module, or the modules can have respective storage modules. Such variations fall within the protection scope of this specification.

Possible beneficial effects of embodiments of this specification include but are not limited to the following: (1) an entity in an existing knowledge graph is inherited to obtain a more pertinent child entity, and knowledge processing or fusion performed based on the child entity can further deepen knowledge mining and utilization; (2) when a knowledge inheritance method is performed, only increment information of instance data of the child entity is stored, so that occupation of storage space is reduced; (3) modified or added data are stored as increment data, so that direct modifications to the knowledge graph where a parent entity is located can be reduced.

It is worthwhile to note that beneficial effects that may be generated in different embodiments are different. The beneficial effects that may be generated in different embodiments can be any one or a combination of the previous beneficial effects, or can be any other beneficial effect that may be achieved.

Basic concepts have been previously described. Clearly, for a person skilled in the art, the previous detailed disclosure is merely an example, but does not constitute a limitation on this specification. Although not expressly stated here, a person skilled in the art may make various modifications, improvements, and amendments to this specification. Such modifications, improvements, and amendments are proposed in this specification. Therefore, such modifications, improvements, and amendments still fall within the spirit and scope of the example embodiments of this specification.

Meanwhile, specific words are used in this specification to describe the embodiments of this specification. For example, terms such as “one embodiment”, “an embodiment”, and/or “some embodiments” mean that a certain feature, structure, or characteristic is related to at least one embodiment of this specification. Therefore, it is worthwhile to emphasize and note that “one embodiment”, “an embodiment”, or “an alternative embodiment” mentioned twice or more times in different locations in this specification does not necessarily refer to the same embodiment. In addition, some features, structures, or characteristics in one or more embodiments of this specification can be combined as appropriate.

In addition, unless expressly stated in the claims, the order of the processing elements and sequences, the use of numerals and letters, or the use of other names described in this specification is not intended to limit the order of the procedures and methods described in this specification. Although some embodiments of this application that are considered useful currently are discussed by using various examples in the previous disclosure, it should be understood that such details are for illustrative purposes only, that the additional claims are not limited to the disclosed embodiments, and that the claims are intended to cover all modifications and equivalent combinations that conform to the essence and scope of the embodiments of this specification. For example, although the system components previously described can be implemented by a hardware device, the system components can be implemented only by a software solution, for example, installing the described system on an existing server or mobile device.

Similarly, it is worthwhile to note that, in order to simplify the description disclosed in this specification and help understand one or more embodiments of this application, in the previous descriptions of the embodiments of this specification, a plurality of features are sometimes incorporated into one embodiment, drawing, or descriptions thereof. However, this disclosure method does not mean that features needed by the object of this specification are more than the features mentioned in the claims. In fact, the features of the embodiments are less than all features of previously disclosed individual embodiments.

Some embodiments use numerals describing quantities of components and attributes, and it should be understood that such numerals used for the description of embodiments are modified with modifiers such as “about”, “approximately”, or “generally” in some examples. Unless otherwise stated, “about”, “approximately”, or “generally” indicates that a change of ±20% is allowed for the numeral. Correspondingly, in some embodiments, values and parameters used in the specification and claims are approximations, and the approximations can be modified based on features needed by individual embodiments. In some embodiments, for values and parameters, the specified quantity of significant digits should be taken into account and a general digit retention method should be used. Although value ranges and parameters used to determine the range thereof in some embodiments of this specification are approximations, in specific embodiments, such values are set as precisely as possible in a feasible range.

Each patent, patent application, and patent application publication and other materials such as articles, books, specifications, publications, or documents are incorporated into this specification here by reference in its entirety, except for the historical application documents that are inconsistent or conflicting with the content of this specification, and the documents (attached to this specification currently or later) that limit the widest scope of the claims of this specification. It is worthwhile to note that, if at least one of the description, definition, or use of the terms in the attachments of this specification is inconsistent or conflicting with the content of this specification, at least one of the description, definition, or use of the terms of this specification shall prevail.

Finally, it should be understood that the embodiments described in this specification are merely used to describe the principles of the embodiments of this specification. Other variations may also fall within the scope of this specification. Therefore, by way of example instead of limitation, alternative configurations of the embodiments of this specification can be considered to be consistent with the teachings of this specification. Correspondingly, embodiments of this specification are not limited to the embodiments specifically described in this specification.

What is claimed is:

1. A computer-implemented method for knowledge reuse, comprising:
defining a child entity based on a parent entity, wherein the parent entity is selected from entities in a knowledge graph;
performing a knowledge inheritance method, to inherit a portion of instance data of the parent entity;
determining instance data of the child entity; and
storing first graph increment information corresponding to the instance data of the child entity.

2. The computer-implemented method according to claim 1, wherein:
the knowledge inheritance method is used to screen instance data of the parent entity, and use instance data of the parent entity that satisfy a screening condition as the instance data of the child entity, and
the first graph increment information indicates index information of the instance data of the parent entity that satisfy the screening condition.

3. The computer-implemented method according to claim 2, wherein the instance data comprise attribute data of an instance.

4. The computer-implemented method according to claim 3, wherein:
the knowledge inheritance method is further used to modify one or more pieces of attribute data inherited from the instance data of the child entity, and
the first graph increment information further comprises the modified one or more pieces of attribute data.

5. The computer-implemented method according to claim 3, wherein the knowledge inheritance method is further used to add one or more pieces of attribute data to the instance data of the child entity, and the first graph increment information further comprises the added one or more pieces of attribute data.

6. The computer-implemented method according to claim 1, further comprising:
determining an entity to be fused, wherein the entity to be fused is selected from entities in another knowledge graph; and
performing a knowledge fusion method to obtain a fused knowledge graph by processing instance data of the entity to be fused and the instance data of the instance data of the child entity.

7. The computer-implemented method according to claim 6, wherein the knowledge fusion method is used to combine the instance data of the entity to be fused and the child entity to obtain instance data of a fused entity in the fused knowledge graph.

8. The computer-implemented method according to claim 6, wherein the knowledge fusion method is used to generate instance data of an edge between the instance data of the entity to be fused and the instance data of the child entity, and the fused knowledge graph comprises the instance data respectively corresponding to the entity to be fused, the child entity, and the edge.

9. The computer-implemented method according to claim 1, further comprising:
determining an entity to be fused, wherein the entity to be fused is selected from the entities in the knowledge graph; and
performing a knowledge processing method to obtain second graph increment data by processing instance data corresponding to the entity to be fused and the instance data of the child entity.

10. The computer-implemented method according to claim 9, wherein the knowledge processing method is used to generate instance data of an edge between the instance data of the entity to be fused and the instance data of the child entity, and the second graph increment data comprise the instance data of the edge.

11. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
defining a child entity based on a parent entity, wherein the parent entity is selected from entities in a knowledge graph;
performing a knowledge inheritance method, to inherit a portion of instance data of the parent entity;
determining instance data of the child entity; and
storing first graph increment information corresponding to the instance data of the child entity.

12. The computer-implemented system according to claim 11, wherein:
the knowledge inheritance method is used to screen instance data of the parent entity, and use instance data of the parent entity that satisfy a screening condition as the instance data of the child entity, and
the first graph increment information indicates index information of the instance data of the parent entity that satisfy the screening condition.

13. The computer-implemented system according to claim 12, wherein the instance data comprise attribute data of an instance.

14. The computer-implemented system according to claim 13, wherein:
the knowledge inheritance method is further used to modify one or more pieces of attribute data inherited from the instance data of the child entity, and
the first graph increment information further comprises the modified one or more pieces of attribute data.

15. The computer-implemented system according to claim 13, wherein the knowledge inheritance method is further used to add one or more pieces of attribute data to the instance data of the child entity, and the first graph increment information further comprises the added one or more pieces of attribute data.

16. The computer-implemented system according to claim 11, wherein the one or more operations further comprise:
determining an entity to be fused, wherein the entity to be fused is selected from entities in another knowledge graph; and
performing a knowledge fusion method to obtain a fused knowledge graph by processing instance data of the entity to be fused and the instance data of the instance data of the child entity.

17. The computer-implemented system according to claim 16, wherein the knowledge fusion method is used to combine the instance data of the entity to be fused and the child entity to obtain instance data of a fused entity in the fused knowledge graph.

18. The computer-implemented system according to claim 16, wherein the knowledge fusion method is used to generate instance data of an edge between the instance data of the entity to be fused and the instance data of the child entity, and the fused knowledge graph comprises the instance data respectively corresponding to the entity to be fused, the child entity, and the edge.

19. The computer-implemented system according to claim 11, wherein the one or more operations further comprise:
determining an entity to be fused, wherein the entity to be fused is selected from the entities in the knowledge graph; and
performing a knowledge processing method to obtain second graph increment data by processing instance data corresponding to the entity to be fused and the instance data of the child entity.

20. A non-transitory, computer-readable medium storing one or more instructions executable by a computer system to perform operations comprising:
defining a child entity based on a parent entity, wherein the parent entity is selected from entities in a knowledge graph;
performing a knowledge inheritance method, to inherit a portion of instance data of the parent entity;
determining instance data of the child entity; and
storing first graph increment information corresponding to the instance data of the child entity.
